(19) United States
(12) Patent Application Publication
(10) Pub. No.: US 2026/0359690 A1
(43) Pub. Date: Nov. 12, 2026

(54) SYSTEMS AND METHODS FOR PERFORMING QUANTUM COMPUTATIONS

(71) Applicant: HORIZON QUANTUM COMPUTING PTE. LTD., Singapore (SG)

(72) Inventors: Joseph Francis Fitzsimons, Singapore (SG); Si-Hui Tan, Gentofte (DK); Jayne Thompson, Singapore (SG); Qian Yi Chew, Singapore (SG)

(21) Appl. No.: 19/134,915

(22) PCT Filed: Dec. 1, 2023
(86) PCT No.: PCT/SG2023/050801

§ 371 Date: Jun. 2, 2025

(30) Foreign Application Priority Data
Dec. 5, 2022 (SG) 10202260326W

(51) Int. Cl. G06N 10/20

(52) U.S. Cl. CPC G06N 10/20

(57) ABSTRACT

Computer systems and methods are provided for performing a quantum computation. The system includes digital processors, a memory, and a module. The memory includes a program expressed as blocks. Each block is associated with a transition rule that is one of HALT, ADVANCE, or BRANCH. At least one of the blocks is associated with a transition rule of BRANCH that is dependent on an outcome of a quantum operation. The module executes the blocks, and receives, from a quantum system, a corresponding outcome for each quantum operation. The module executes a first block in the blocks. If the first block is associated with the transition rule of BRANCH that is dependent on an outcome of a quantum operation, the module receives the outcome of the quantum operation in accordance with a branch of the first block, and branches to a second block or a third block, based on the outcome.

### CROSS REFERENCE TO RELATED APPLICATIONS

This application claims priority to Singapore Patent Application No. 10202260326W, entitled “Systems and Methods for Performing Quantum Computations,” filed Dec. 5, 2022, which is hereby incorporated by reference in its entirety.

### TECHNICAL FIELD

The present disclosure relates generally to execution of code that performs the equivalent of an adaptive quantum algorithm using a combination of digital computing and quantum gate level computing.

### BACKGROUND

Utilizing quantum computations require different considerations than classical computations. One such consideration is that the architecture of quantum computers differs considerably from architectures of classical (digital) computers. As such, an aspect of this consideration is the differences in available computational operations for quantum computers and classical computers. For instance, when utilizing quantum computers, an error may occur due to an inherent aspect of a quantum system. As one example, a user can provide an operational command as input anticipating a first operation executed at a gate, but actually observe that the gate conducts a second operation other than the first operation in response to the input.

A Quantum Turing machine is a model of computation that intends to capture the full range of functions that can be computed by quantum processors, up to at most some overhead polynomial in the size of the input. It is a generalization of the well-known Turing machine, which plays a similar role for conventional (classical) computation. A distinguishing feature of quantum Turing machines (as with their classical counterpart) is that it is not in general possible to tell how long it will take a quantum Turing machine to run. This is because the states the head will pass through cannot generally be determined without doing something equivalent to simulating the quantum Turing machine, and so a priori it may not be possible to tell when the machine enters a final (halting) state. The position of the head is also described by a position that can take on an infinite number of values in quantum superposition (which corresponds to a continuous variable).

Conventional programming frameworks for quantum computing operate in the quantum circuit model, rather than in the Turing machine model. Generally, quantum circuits consist of nonadaptive sequences of elementary quantum operations, such as the preparation of states of individual quantum systems (such as qubits, qudits, and/or quantum continuous variables), the application of logic gates, such as CNOTs, single qubit rotations, measurements and potentially gate applications conditioned on classical variables (for example stemming from the results of measurements). Occasionally, more complex operations that could in principle be broken down into quantum circuits themselves will be included.

Quantum circuits are analogous to logic circuits in classical computer science, and can easily be characterized in terms of the depth (essentially the amount of time the circuit will take to run on a parallelized quantum processor) and breadth (the number of physical qubits, qudits, and/or quantum continuous variables or other quantum systems necessary at any particular point in time). The restriction to quantum circuits within quantum programming frameworks is limiting, since it can only express computations that have a runtime that is known ahead of time, independent of input, and that require at most some fixed amount of memory for inputs of the same length. This restriction in turn imposes several restrictions discussed next.

Many classical programs cannot be converted into quantum circuits, and hence cannot be programmed as subroutines within quantum algorithms using the common programming frameworks. This is because these classical programs may contain structures, such as while loops, for which it is impossible or impractical to compute the exact number of passes/operations at compile time. General quantum Turing machines cannot satisfactorily be implemented or simulated using individual quantum circuits.

Some quantum systems cannot be directly simulated using quantum circuits. For example, a photon passing through an interferometer will have a distribution of exit times, and so will efficiently sample from this distribution. It is not possible to write a quantum circuit that samples from an identical distribution, although a quantum Turing machine could indeed produce such a sample. One might expect that such a simple setup could be easily directly simulated by a simple quantum computer and quantum programming framework, but this is not presently the case.

Accordingly, what is needed in the art are systems and methods for direct simulation of quantum systems using currently available quantum processors and/or conventional digital computers.

### SUMMARY

The present disclosure addresses the above-identified shortcomings by introducing systems and methods for performing quantum computations using classical computers and controllable quantum systems. While the architectures of quantum and classical computers are indeed different, it is the differences in the underlying computational model that motivated the basis for the approach taken in the systems and methods of the present disclosure. With the techniques described herein, it is possible to implement or simulate a quantum Turing machine, using individual quantum circuits. In other words, it is possible to implement an adaptive quantum algorithm using the systems and methods of the present disclosure. An example of an adaptive quantum algorithm is one in which a branch decision is made dependent upon the outcome of a quantum operation. For instance, a while loop may repeat until a quantum operation obtains a certain value.

As such, the disclosed techniques may be used for converting any classical program into quantum circuits, including programs that contain structures, such as while loops for which it is impossible or impractical to compute the exact number of passes/operations at compile time.

One aspect of the present disclosure provides a computer system for performing a quantum computation. The system comprises one or more digital processors, a memory and a module. The memory includes a program expressed as a plurality of blocks. Each block is associated with a transition rule that is one of HALT, ADVANCE, or BRANCH. Each block includes one or more instructions to be performed by the one or more digital processors. At least one of the blocks is associated with a transition rule of BRANCH that is dependent on an outcome of a quantum operation. The module is configured to (i) execute the plurality of blocks, and (ii) receive, from a quantum system, a corresponding outcome for each quantum operation. The module is configured to execute a first block in the plurality of blocks. In accordance with a determination that the first block is associated with the transition rule of BRANCH that is dependent on a first outcome of a first quantum operation, the module receives the first outcome of the first quantum operation in accordance with a branch of the first block, and branches to a second block or a third block of the plurality of blocks, based on the first outcome of the quantum operation.

In some embodiments, the plurality of blocks includes a fourth block that is associated with the transition rule of BRANCH that is dependent on an outcome of a second quantum operation. The fourth block is in a branch of the program defined by either the second block or the third block. The module is further configured to one or more of the following steps: (a) cause the quantum system to perform the first quantum operation, a first plurality of times, to obtain a plurality of first instances of an outcome of the first quantum operation; (b) select a first instance of an outcome from the plurality of first instances of the outcome, of the first quantum operation; (c) store the selected first instance of the outcome of the first quantum operation in the memory; (d) perform a plurality of runs. Each respective run in the plurality of runs: causes the quantum system to perform the first quantum operation, on the quantum system, to obtain a corresponding second instance of the outcome of the first quantum operation, and causes the quantum system, after performing the first quantum operation of the respective run, to perform the second quantum operation, irrespective of a value of the second instance of the outcome of the first quantum operation, to obtain a corresponding first instance of an outcome of the second quantum operation. In this way, the module obtains a plurality of results, each result in the plurality of results corresponding to a respective run in the plurality of runs and including a second instance of the outcome of the first quantum operation and a first instance of the outcome of the second quantum operation corresponding to the respective run; (e) generate a random number using a distribution of the first instance of the outcome of the second quantum operation across only those runs in the plurality of runs in which the corresponding second instance of the outcome of the first quantum operation of the respective runs matches the selected first instance of the outcome of the first quantum operation; (f) store the random number as a selected first instance of the outcome for the second quantum operation; and (g) branch from the fourth block to a fifth or sixth block in the plurality of blocks, based on the selected first instance of the outcome for the second quantum operation.

In some embodiments, the module is coupled to the memory, the one or more digital processors and the quantum system. The module is configured according to a finite state machine, to be in a state of a plurality of states of the finite state machine. Each block of the plurality of blocks corresponds to a state. The module is configured to: upon entering a state of the plurality of states, perform a sequence of operations, using the memory, the one or more digital processors, and the quantum system; and after the sequence of operations, transition to another state, based on the transition rule of HALT, ADVANCE, or BRANCH.

In some embodiments, the sequence of operations includes obtaining input from a user to the memory or transmitting variables stored in the memory to the user.

In some embodiments, the user is an operator of the system, another system or network, or a combination thereof.

In some embodiments, each state of the plurality of states includes a predetermined set of successor states to transition to.

In some embodiments, the module is further configured to, upon determination that the predetermined set of successor states is empty for a state that has no successor states, halt execution, thereby allowing the memory to be read out.

In some embodiments, the module is further configured to, upon determination that a current state has no successor states, applying the HALT transition rule to cease performing computations after performing operations corresponding to the current state.

In some embodiments, the module is further configured to: upon determination that a current state has a single successor state, applying the ADVANCE transition rule to transition to the single successor state after performing operations corresponding to the current state.

In some embodiments, the module is further configured to: upon determination that a current state has multiple successor states, applying the BRANCH transition rule to transition to one of the successor states after performing operations corresponding to the current state.

In some embodiments, the outcome of the first quantum operation is a measurement outcome for one or more qubits, qudits, or quantum continuous variables (QCVs) defined by the first block.

In some embodiments, the first block includes a series of quantum gate level operations.

In some embodiments, the first block defines a quantum data structure.

In some embodiments, the quantum system includes subsystems comprising qubit, qudits, and/or quantum continuous variables configured to perform quantum gates and be subjected to quantum measurements.

In some embodiments, the memory is configured to store numerical data, where in the module is further configured to index and/or address individual quantum systems of the subsystems.

Another aspect of the present disclosure provides a method of performing a quantum computation using a system comprising (a) one or more digital processors, (b) a memory comprising a program expressed as a plurality of blocks. Each block is associated with a transition rule that is one of HALT, ADVANCE, or BRANCH. Each block includes one or more instructions. In some embodiments the instructions are to be performed by the one or more digital processors. In some embodiments some of the instructions are to be performed by the one or more digital processors and some of the instructions represent gates to be performed by one or more quantum processors. A first block in the plurality of blocks is associated with a transition rule of BRANCH that is dependent on an outcome of a first quantum operation. The system further comprises a module. The method includes, at the module: (i) executing the plurality of blocks, and (ii) receiving, from a quantum system, a n outcome for the first quantum operation, including executing the first block. In accordance with a determination that the first block is associated with the transition rule of BRANCH that is dependent on the outcome of the first quantum operation: the method includes receiving the outcome of the first quantum operation in accordance with a branch of the first block; and branching to a second block or a third block of the plurality of blocks, based on the outcome of the first quantum operation.

In some embodiments, the plurality of blocks includes a fourth block that is associated with the transition rule of BRANCH that is dependent on an outcome of a second quantum operation. The fourth block is in a branch of the program defined by either the second block or the third block. The method further includes, at the module: (i) causing the quantum system to perform the first quantum operation, a first plurality of times, to obtain a plurality of first instances of an outcome of the first quantum operation; (ii) selecting a first instance of an outcome from the plurality of first instances of the outcome of the first quantum operation; (iii) storing the selected first instance of the outcome of the first quantum operation in the memory; (iv) performing a plurality of runs. Each respective run in the plurality of runs: causes the quantum system to perform the first quantum operation, on the quantum system, to obtain a corresponding second instance of the outcome of the first quantum operation, and causes the quantum system, after performing the first quantum operation of the respective run, to perform the second quantum operation, irrespective of a value of the second instance of the outcome of the first quantum operation, to obtain a corresponding first instance of an outcome of the second quantum operation, thereby obtaining a plurality of results, each result in the plurality of results corresponding to a respective run in the plurality of runs and including a second instance of the outcome of the first quantum operation and a first instance of the outcome of the second quantum operation corresponding to the respective run; (v) generating a random number using a distribution of the first instance of the outcome of the second quantum operation across only those runs in the plurality of runs in which the corresponding second instance of the outcome of the first quantum operation of the respective runs matches the selected first instance of the outcome of the first quantum operation; (vi) storing the random number as a selected first instance of the outcome for the second quantum operation; and (vii) branching from the fourth block to a fifth or sixth block in the plurality of blocks, based on the selected first instance of the outcome for the second quantum operation.

In some embodiments, the module is coupled to the memory, the one or more digital processors and the quantum system. The module is configured according to a finite state machine, to be in a state of a plurality of states of the finite state machine. Each block of the plurality of blocks corresponds to a state. The method further includes: at the module: upon entering a state of the plurality of states, perform a sequence of operations, using the memory, the one or more digital processors, and the quantum system; and after the sequence of operations, transition to another state, based on the transition rule of HALT, ADVANCE, or BRANCH.

In some embodiments, the sequence of operations includes obtaining input from a user to the memory or transmitting variables stored in the memory to the user.

Another aspect of the present disclosure provides a non-transitory computer readable storage medium storing a module and a program expressed as a plurality of blocks. Each block is associated with a transition rule that is one of HALT, ADVANCE, or BRANCH. A first block in the plurality of blocks is associated with a transition rule of BRANCH that is dependent on an outcome of a first quantum operation. Each block in the plurality of blocks includes one or more instructions. In some embodiments the one or more instructions are executed by a digital computer system with one or more digital processors. In some embodiments the one or more instructions are executed by a quantum computer system. In some embodiments at least one of the one or more instructions is executed by a quantum computer system while another of the one or more instructions is executed by a quantum computer system. The module when executed by a digital computer system causes the digital computer system to: (i) execute the plurality of blocks, and (ii) receive, from a quantum system, a corresponding outcome for the quantum operation. This includes executing the first block. In accordance with a determination that the first block is associated with the transition rule of BRANCH that is dependent on the outcome of the first quantum operation: the digital computer system receives the outcome of the first quantum operation in accordance with a branch of the first block; and branches to a second block or a third block of the plurality of blocks, based on the outcome of the first quantum operation.

### BRIEF DESCRIPTION OF DRAWINGS

FIG. 1 is a schematic diagram showing aspects of an example system that includes both a digital computer system and a quantum computer, in accordance with an embodiment of the present disclosure.

FIG. 2 is a schematic diagram of a digital computer system for compiling computing language code into code that can be run on quantum computers and/or digital computers in accordance with an embodiment of the present disclosure, in which optional elements are indicated by dash boxes and/or dash lines.

FIG. 3 is a schematic diagram of an example system for performing quantum computations, in accordance with an embodiment of the present disclosure.

FIG. 4 is a schematic diagram of an example block layout, in accordance with an embodiment of the present disclosure.

FIGS. 5A and 5B show a flow chart for an example method for performing quantum computations, in accordance with an embodiment of the present disclosure.

FIG. 6 illustrates how instructions within blocks of the present disclosure can be coded so that they can be deployed on a quantum system.

FIG. 7 illustrates and example of branched logic that can be implemented into blocks in accordance with some embodiments of the present disclosure so that they can be deployed on a quantum system.

Like reference numerals refer to corresponding parts throughout the several views of the drawings.

### DESCRIPTION

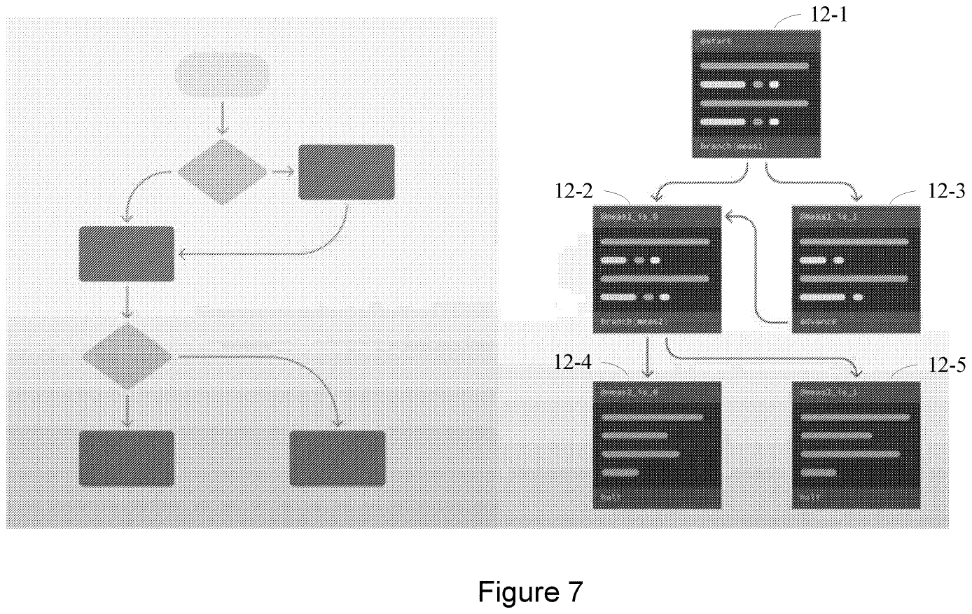

Disclosed are computer systems and methods for performing a quantum computation. The system includes digital processors, a memory, and a module. The memory includes a program expressed as blocks. Each block is associated with a transition rule that is one of HALT, ADVANCE, or BRANCH. At least one of the blocks is associated with a transition rule of BRANCH that is dependent on an outcome of a quantum operation. The module executes the blocks, and receives, from a quantum system, a corresponding outcome for the quantum operation. The module executes a first block in the blocks. If the first block is associated with the transition rule of BRANCH that is dependent on an outcome of a quantum operation, the module receives the outcome of the quantum operation in accordance with a branch of the first block, and branches to a second block or a third block, based on the outcome. In this way, the systems and methods of the present disclosure support adaptive situations such as shown in FIG. 7 where adaptive logic is used to decided between various branch points in a logical sequence. Advantageously, where applicable portions of the adaptive logic are encoded in quantum gates and such quantum gates can be controlled by adaptive logic in order to support adaptive quantum programs.

Suppose the blocks include a fourth block that is associated with the transition rule of BRANCH that is dependent on an outcome of a second quantum operation. Further suppose the fourth block is in a branch of the program defined by either the second block or the third block. In such cases, the module causes the quantum system to perform the first quantum operation, a first plurality of times, to obtain a first plurality of outcomes. The module may also: randomly select a first outcome from the first plurality of outcome, for the first quantum operation; store the first outcome in the memory. The module may also perform a plurality of runs. Each respective run in the plurality of runs causes the quantum system to perform the first quantum operation, on the quantum system, to obtain an instance of the first outcome, and causes the quantum system, after performing the first quantum operation of the respective run, to perform the second quantum operation, irrespective of a value of the instance of the first outcome, to obtain an instance of a third outcome. In this way, the module obtains a plurality of results. Each result in the plurality of results corresponds to a respective run in the plurality of runs and includes an instance of the first outcome and an instance of the third outcome corresponding to the respective run. The module may also generate a random number using a distribution of the third outcome across only those runs in the plurality of runs in which the second outcome matches the first outcome. The module may also store the random number as a second outcome for the second quantum operation. The module may also branch from the fourth block to a fifth or sixth block in the plurality of blocks, based on the second outcome for the second quantum operation.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first code could be termed a second code, and, similarly, a second code could be termed a first code, without departing from the scope of the present disclosure. The first code and the second code are both code, but they are not the same code.

The terminology used in the present disclosure is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

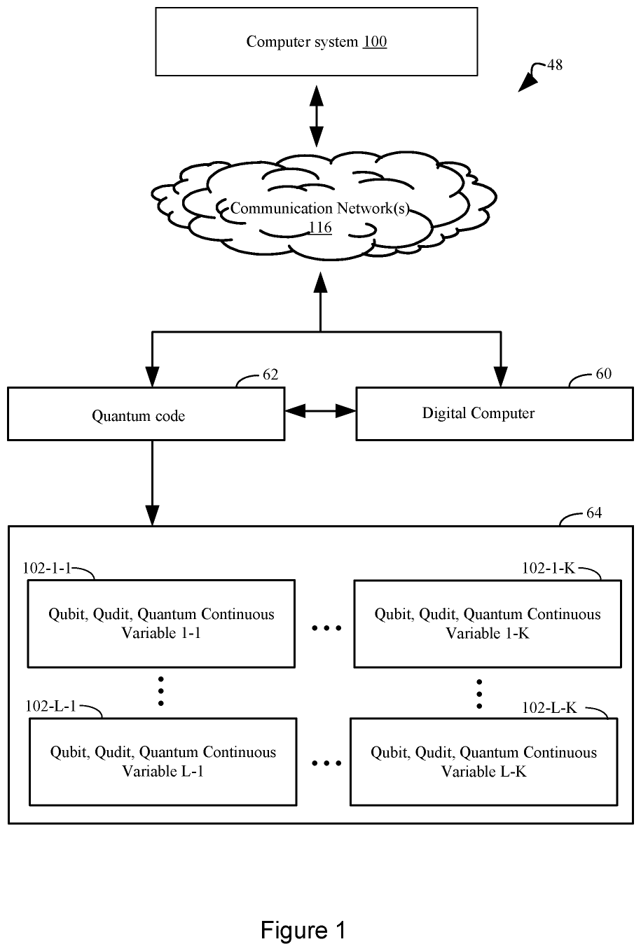

FIG. 1 illustrates a computer system topology 48 for providing a language that can be compiled and run using both a digital computer 60 and one or more quantum systems 64. Such quantum systems 64 comprise a plurality of qubits, qudits, or quantum continuous variables 102. Referring to FIG. 1, in typical embodiments, the topology includes a computer system 100 that is in electronic communication with the one or more quantum systems 64 that include a plurality of qubits, qudits, or quantum continuous variables 102 and the digital computer 60. In some embodiments, the computer system 100 and the digital computer 60 are the same computer or same computer system. In some embodiments the electronic communication between the computer system 100 and the one or more quantum systems 64 is over a communication network 116. In some embodiments, the computer system 100 applies suitable quantum code 62 to the one or more quantum systems 64.

For purposes of illustration in FIG. 1, the computer system 100 and the digital computer system 60 are each represented as a single respective computer that includes all of the functionality of digital computer systems. However, the disclosure is not so limited. The functionality of the computer system 100 and/or digital computer 60 may be spread across any number of networked computers and/or reside on each of several networked computers. One of skill in the art will appreciate that a wide array of different computer topologies is possible for the computer system 100 and all such topologies are within the scope of the present disclosure.

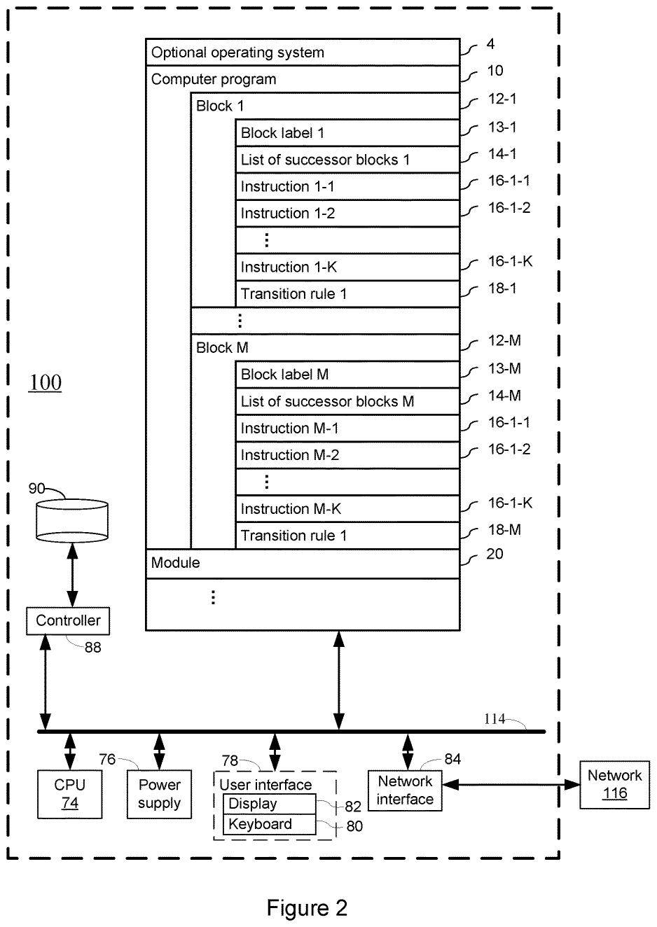

Turning to FIG. 2 with the foregoing in mind, a computer system 100 comprises one or more processing units (CPU's) 74, a network or other communications interface 84, a user interface 78 (e.g., including an optional display 82 and optional keyboard 80 or, optionally, another form of input device) a memory 92 (e.g., random access memory), one or more magnetic disk storage and/or persistent devices 90 optionally accessed by one or more controllers 88, one or more communication busses 114 for interconnecting the aforementioned components, and a power supply 76 for powering the aforementioned components. Data in memory 92 can be seamlessly shared with non-volatile memory 90 using known computing techniques such as caching. Memory 92 and/or memory 90 can include mass storage that is remotely located with respect to the central processing unit(s) 74. In other words, some data stored in memory 92 and/or memory 90 may in fact be hosted on computers that are external to compiler computer system 100 but that can be electronically accessed by the compiler computer system over an Internet, intranet, or other form of network or electronic cable using network interface 84.

The memory 92 of the computer system 100 stores:
an optional operating system 4 that includes procedures for handling various basic system services;
a computer program 10 that includes one or more quantum operations, the computer program organized into a plurality of blocks 12, each respective block 12 including one or more instructions 16 and a transition rule 18;
a module 20 for orchestrating the computer program 10 so that at least portions of the computer program can be run one or more target quantum systems, each such quantum system comprising a plurality of qubits, qudits or quantum continuous variables.

In some implementations, one or more of the above identified data elements or modules of the compiler computer system 100 are stored in one or more of the previously disclosed memory devices, and correspond to a set of instructions for performing a function described above. The above identified data, modules or programs (e.g., sets of instructions) need not be implemented as separate software programs, procedures or modules, and thus various subsets of these modules may be combined or otherwise re-arranged in various implementations. In some implementations, the memory 92 and/or 90 optionally stores a subset of the modules and data structures identified above. Furthermore, in some embodiments the memory 92 and/or 90 stores additional modules and data structures not described above.

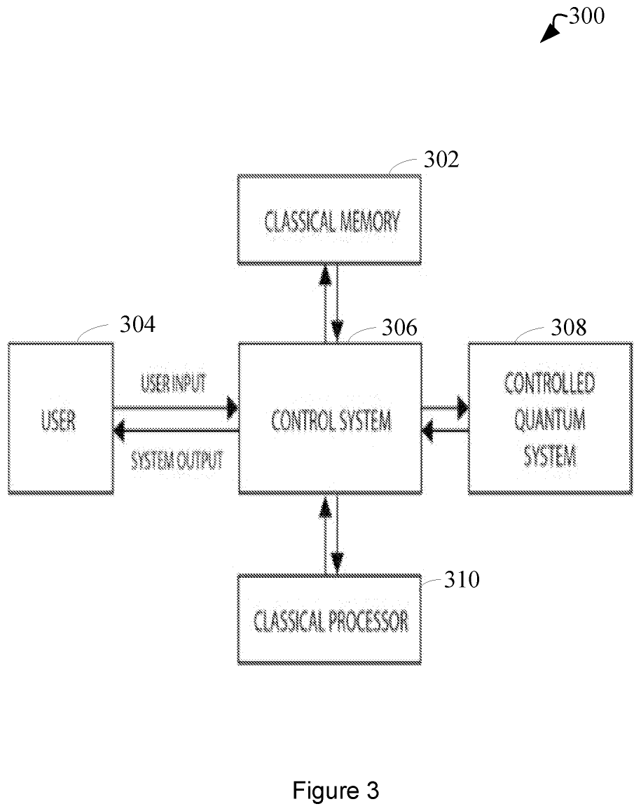

FIG. 3 shows a schematic diagram of an example system 300 for performing quantum computations, according to some embodiments. The system 300 is sometimes referred to as the Control Systems Abstract Machine (CSAM). The CSAM comprises one or more controllable quantum systems 308, a classical memory 302, a classical processor 310, and a control system 306, each of which is described below. Because this is in the context of quantum computation, the CSAM has the ability to efficiently simulate a quantum Turing machine described in Deutsch, 1985, “Quantum theory, the Church-Turing principle and the universal quantum computer,” Proceedings of the Royal Society of London. A. Mathematical and Physical Sciences 400.1818, pp. 97-117, as well as The article en.wikipedia.org/wiki/Quantum_Turing_machine, accessed on the Internet Nov. 29, 2023, which is hereby incorporated by reference.

For the sake of illustration and ease of explanation, operations are sometimes described with respect to an abstract machine. With respect to FIG. 2, the classical memory 302 may be implemented using and sometimes referred to as the memory 92. The CPU 74 is an example of the classical processor 310, although any conventional CPU, GPU, FPGA, an ASIC, or a combination thereof, may be used to implement the functionality described herein, with respect to the classical processor 310. The control system 306 may be implemented as part of the module 20.

In some embodiments, a controllable quantum system 308 includes individual subsystems, such as qubits, qudits, quantum continuous variables etc., upon which quantum gates and measurements can be performed. Examples of quantum gates that can be performed using the systems and methods of the present disclosure are described on the Internet at en.wikipedia.org/wiki/Quantum_circuit, accessed Nov. 29, 2023; Nielsen and Chuang, 2001, “Quantum computation and quantum information,” Phys. Today 54.2, p. 60; and Nielsen and Chuang, Quantum Computation and Quantum Information, 2010, Cambridge University Press, New York, each of which is hereby incorporated by reference. In a typical instance, the quantum subsystems are qubits, but in general they may have more than two levels, and some embodiments operate with infinite number of levels (known as quantum continuous variables). It is possible for the controllable system to contain a range of different subsystem types. Some embodiments explicitly allow for an arbitrary mixture of subsystems.

In some embodiments, the computer program 10 is compiled to run on quantum hardware. A controllable quantum system 308 may be implemented using a quantum processor or some part of a quantum processor, or may be composed of multiple components, such as one or more quantum processors with separate memory.

The classical memory 302 is used to store values of classical variables including any classical input to the program. The classical memory 302 may be used to store multiple types of data. Some embodiments use two data types, and arrays of each type, though more types can be accommodated. The two types of data are a numeric type, which can be used to represent numbers, and an address type, used to store an identifier for individual quantum subsystems. It can readily be recognized that a numeric data can be used to index and address individual quantum systems, so that it is possible to make do with only a single type. The system is described herein using separate address and numeric types, for clarity of exposition.

The classical processor 310 evaluates classical (non-quantum) functions on data stored in the classical memory.

The control system 306 acts as a finite state machine with access to both the classical memory, controllable quantum system and the classical computer. The control system 306 has some finite number of states. Upon entering a state, the control system 306 performs some prescribed sequence of operations with the classical memory 302, the classical processor 310, and the controllable quantum subsystem 308. Once this sequence of operations is complete, the system 300 transitions to a new state according to a preset rule. These operations may also include reading in of user input to the classical memory or transmitting variables stored in the classical memory to the user. In this context, the ‘user’ 304 may be either the operator of the device or some other computer system or network, or some combination thereof. Although FIG. 3 shows the user 304 as part of the system 300, this is only for the sake of illustration. The system 300 may work independent of, and may be distinct from, the user 304.

In the following discussion, the term “block” and “state” are used. When the control system 306 executes a respective block in the plurality of blocks of a program, the control system 306 is considered to be in a state defined by the respective block. With this in mind, for convenience, the terms “block” and “state” are interchangeably used in the following discussion.

Each state is associated with a set of prescribed successor states that it may transition into. If a state has no successor states, then the system will halt, allowing for the classical memory to be read out. Some embodiments use at least three types of transition rules 18, though it is possible to add additional transition rules for convenience:
HALT—This transition rule applies when there are no successor states for the current state (e.g., no further instructions 16 to execute in the current block and no successor blocks identified by the current block). The system will cease performing computation within the associated block 12 once the list of operations (instructions 16) for the current state has been executed.
ADVANCE—This transition rule applies when there is a single successor state identified in the current block. The system will transition deterministically to the successor state (block) once the list of operations (instructions 16) for the current state (block) has been executed. In one such example, the “advance” transition rule advances to another block 12 in the plurality of blocks of the computer program 10 that is specified by the current block.
BRANCH(var)—This transition rule applies when there are multiple possible successor states (blocks). Once the list of operations (instructions 16) for the current state (current block 12) has been executed, the system will transition to the successor state (block) indexed by the numeric variable var stored in the classical memory. Some embodiments treat the list of possible successor states as a zero-indexed array and take the value of var rounded to the nearest integer to index to a single successor state in this array in which to transition. In some instances, the behavior of the system may be rounded to an integer which is not a valid index for the array of successor states is not defined, though in common implementations it is expected to enter a special error halting state, indicating that the computation failed to complete correctly. Compilation techniques from higher level languages described below avoid the possibility of entering such an error state.

Optionally, in some embodiments, the system 300 is augmented with additional capabilities, such as the ability to transmit quantum information to/from the user interface, with the operation of such capabilities available to the control system for execution within the fixed lists of operations executed when entering a particular state.

### Example Program Structure

In some embodiments, with further reference to the FIG. 2, computer program 10 is structured in terms of blocks 12, with each block representing a state of the control system 306 (e.g. Module 20 of FIG. 2). In some embodiments, the computer program 10 comprises 2, 3, 4, 5, 6, 7, 8, 9, 10, 20, 30, 50, 100, 250, 500, 1000, or more than 10,000 blocks.

Each block contains at least four different elements or parts, in accordance with some embodiments. The first element is a block label 13 for the block. The label for each block is unique, and in some embodiments, there is a special label reserved for the starting block corresponding to the initial state of the control system 306 (e.g., module 20) when the program is executed.

The second element of a block is a list of possible successor blocks 14 (corresponding to successor states for the control system 306/module 20 acting as a finite state machine controller).

The third element of a block is a list of operations (instructions 16) to execute upon entering the corresponding control system state. These operations may include any combination of the following:
reading user input to classical memory 302;
returning numeric variables stored in the classical memory 302 to the user 304;
assigning numeric values to variables or arrays stored in the classical memory 302 (these may stem from:
   results from measurements performed on the controlled quantum system 308,
   results from classical computations taking as input fixed numeric values, one or more numeric variables stored in the classical memory 302, or any combination of these, and/or
   numeric variables stored in the classical memory 302;
assigning of address values to variables or arrays stored in the classical memory 302 (these may arise from:
   duplicating the address of one or more quantum subsystems of the controllable quantum system 308,
   memory allocations, which allocate one or more quantum subsystems of the controllable quantum system 308 to a particular address type variable or address type array (an example of this is qubit, qudit, or quantum continuous variable creation, where a new qubit, qudit or quantum continuous variable is allocated for use and initialized in a well-defined state), and/or
   optionally, explicitly assigning the address of a particular quantum subsystem of the controllable quantum system 308 to an address type variable;
performing operations on the controlled quantum system 308 (e.g., operations such as state preparation, unitary quantum gates, measurements of quantum subsystems and/or hybrid operations that combine facets of more than one basic operation type);
performing calculations and storing the result in the classical memory 302 (these calculations may take as zero, one or more input variables stored in the classical memory 302);
optionally, timing instructions may be included, such as pausing for some specified period of time (such instructions require that the system 300 be augmented with a clock accessible from the control system 306);
optionally, performing operations necessary to control any additional components connected to the system 300, such as capabilities for quantum communications or a quantum random access memory.

The fourth element of a block is a transition rule 18 for choosing the next state to transition to. Each rule is one of either the HALT, ADVANCE or BRANCH rules described for the CSAM (control system 306) above.

In some embodiments, blocks 12 are written as follows

<block_label> | <successor_label_1> , ... , <successor_label_n>
<operation_list>
<rule>

where <block_label> corresponds to block label 13 of FIG. 2, <successor_label_1>, . . . <successor_label_n> (where n is a positive integer) corresponds to list of successor blocks 14 of FIG. 2, <operation_list> corresponds to instructions 16 in a block 1 of FIG. 2, and <rule> corresponds to transition rule 18 of FIG. 2.

In some embodiments, block labels (<block_label>, <successor_label_1>, . . . ) start with an ‘@’ symbol and are followed by a string of letters, numbers and underscores. In some embodiments, the special starting block label is @start.

In some embodiments, <rule> is one of either HALT, ADVANCE or BRANCH(var), where var is the identifier for a numeric variable stored in the classical memory 302.

In some embodiments, advance (sometimes referred to as ADVANCE) may appear only in blocks with a single successor block.

In some embodiments, halt (sometimes referred to as HALT) may appear only in blocks with no successor blocks. In this case the ‘l’ in the opening line of the block is omitted. A ‘#’ symbol followed by any single line text can be included and is treated as a single line comment, having no effect on the program.

### Example Programs

An example Bell Test setup is shown below, according to one or more embodiments. A user input determines program path.

| | |
|---|---|
| 1 | @start \| @meas1_X, @meas1_Y |
| 12-2 | # Read in inputs |
| 3 | input -> setting_1 |
| 4 | input -> setting_2 |
| 5 | # Allocate two qubits |
| 6 | qubit -> a |
| 7 | qubit -> b |
| 8 | # Create Bell pair |
| 9 | h[a] |
| 10 | cnot[a,b] |
| 11 | branch(setting_1) |
| 12 | @meas1_X \| @meas2_P, @meas2_M |
| 13 | h[a] |
| 14 | branch(setting_2) |
| 15 | @meas1_Y\| @meas2_P, @meas2_M |
| 16 | s[a] |
| 17 | h[a] |
| 18 | branch(setting_2) |
| 19 | @meas2_P \| @final |
| 20 | t[b] |
| 21 | h[b] |
| 22 | advance |
| 23 | @meas2_M \| @final |
| 24 | td[b] |
| 25 | h[b] |
| 26 | advance |
| 27 | @final |
| 28 | # Perform measurements |
| 29 | measure[a] -> result_1 |
| 30 | measure[b] -> result_2 |
| 31 | # Output results |
| 32 | result_1 -> output |
| 33 | result_2 -> output |
| 34 | halt |

Lines 1-11 of the above code define the first block of the sample code and is labeled @start, lines 12-14 define the second block of the sample code and is labeled @meas1_X, lines 15-18 define the third block of the sample code and is labeled @meas1_Y, lines 19-22 define the fourth block of the sample code and is labeled @meas2_P, lines 23-26 define the fifth block of the sample code and is labeled @meas2_M, and lines 27-34 define the sixth block of the sample code and is labeled @final.

The first block of the above code specifies that the two possible successor blocks are @meas1_X and @meas1_Y. The first block of the above code reads from input 304 the values of setting_1 and setting_2 at lines 3 and 4. The first block of the above code allocates qubit a and qubit b of the controlled quantum system 308 at lines 7 and 8.

The first block of the above codes creates a Bell pair between qubits a and b at lines 9 and 10 of the code using a Hadamard and a CNOT quantum gate. Specifically, at line 9 of the code a Hadamard gate (H) is applied to qubit a. The Hadamard gate transforms the |0 [symbol] state of qubit a to the |+ [symbol] state, which is a superposition of |0 [symbol] and |1 [symbol] with equal probability. Then, at line 10 of the code a controlled NOT gate (CNOT) is applied with qubit a as the control qubit and qubit b as the target qubit. In a CNOT gate, if the control qubit is in the state |1 [symbol] , it applies a NOT gate to the target qubit. The resulting state is a Bell pair, specifically the Bell state |Φ⁺ [symbol] , which is maximally entangled. The state of qubits a and b is now a superposition of |00 [symbol] and |11 [symbol] with equal probability.

At line 11 of the above code the first block branches to either block @meas1_X or @meas1_Y. The user input at line 3, for setting_1, determines which block program control passes to.

If program control passes from block @start to block @meas1_X, line 13 of the code applies a Hadamard to qubit a. The @meas1_X block of the above code specifies that the two possible successor blocks for this block are @meas2_P and @meas2_M. Once line 13 has been executed, at line 14 of the above code the @meas1_X block branches to either block @meas2_P or @meas2_M. The user input at line 4, for setting_2, determines which block program control passes to for block @meas1_X.

If program control passes from block @start to block @meas1_Y, line 16 of the above code applies a phase gate to qubit a while line 17 of the above code then applies a Hadamard to qubit a. The @meas1_Y block of the above code specifies that the two possible successor blocks for this block are @meas2_P and @meas2_M. Once lines 16 and 17 have been executed, at line 18 of the above code the @meas1_Y block branches to either block @meas2_P or @meas2_M. The user input at line 4, for setting_2, determines which block program control passes to for block @meas1_Y.

If program control passes to block @meas2_P, line 20 of the code applies a T gate to qubit b while line 21 of the code applies a Hadamard gate to qubit b. The @meas2_P block of the above code specifies only one possible successor block for this block, @final. Thus, upon completion of the Hadamard gate to qubit b, process control passes to the @final block in accordance with line 22 of block @meas2_P.

If program control passes to block @meas2_M, line 24 of the code applies a TD quantum gate to qubit b while line 25 of the code applies a Hadamard gate to qubit b. The @meas2_M block of the above code specifies only one possible successor block for this block, @final. Thus, upon completion of the Hadamard gate to qubit b, process control passes to the @final block in accordance with line 26 of block @meas2_M.

When program control passes to @final, line 29 measures the state of qubit a and places the measured state of qubit a in variable result_1 while line 30 measures the state of qubit b and places the measured state of qubit b in variable result_2. Lines 32 and 33 output result_1 and result_2 (e.g., to user 304).

An example teleportation setup is shown below. Here, qubit a is teleported to qubit c requiring measurement-dependent corrections.

| | |
|---|---|
| 1 | @start \| @meas1_is_0, @meas1_is_1 |
| 2 | # Prepare an unusual state to teleport |
| 3 | qubit -> a |
| 4 | rx(0.3927)[a] |
| 5 | rz(-0.1963)[a] |
| 6 | # Create a Bell pair to use for teleportation |
| 7 | qubit -> b |
| 8 | qubit -> c |
| 9 | h[b] |
| 10 | cnot[b,c] |
| 11 | # Do teleportation |
| 12 | cnot[a,b] |
| 13 | h[a] |
| 14 | measure[a] -> meas 1 |
| 15 | measure[b] -> meas2 |
| 16 | # Check correction based on first measurement |
| 16 | branch(meas1) |
| 17 | @meas1_is_0\| @meas2_is_0, @meas2_is_1 |
| 18 | # No correction necessary |
| 19 | # Apply correction based on second measurement |
| 20 | branch(meas2) |
| 21 | @meas1_is_1\| @meas2_is_0, @meas2_is_1 |
| 22 | # Apply Z correction |
| 23 | z[c] |
| 24 | # Check correction based on second measurement |
| 25 | branch(meas2) |
| 26 | @meas2_is_0 |
| 27 | # No correction necessary |
| 28 | halt |
| 29 | @meas2_is_1 |
| 30 | # Apply correction based on second measurement |
| 31 | x[c] |
| 32 | halt |

Lines 1-16 of the above code define the first block of the sample code and is labeled @start, lines 17-20 define the second block of the sample code and is labeled @meas1_is_0, lines 21-25 define the third block of the sample code and is labeled @meas1_Yis_1, lines 26-28 define the fourth block of the sample code and is labeled @meas2_is_0, lines 29-32 define the fifth block of the sample code and is labeled @meas2_is_1.

The first block of the above code specifies that the two possible successor blocks are @meas1_is_0 and @meas1_is_1. The first block of the above code allocates qubit a of the controlled quantum system 308 at 3. Line 4 of the above code then applies a rotation of 0.3927 around the x-axis to qubit a while line 5 of the above codes applies a rotation of 0.1963 around the z-axis to qubit a. This has the effect of preparing qubit a to some unusual state. Line 7 allocates qubit b within the controlled quantum system 308 while line 8 of the above code allocates qubit c. Next, the first block of the above code creates a Bell pair between qubits b and c at lines 9 and 10 of the code using a Hadamard gate and a CNOT quantum gate. Specifically, at line 9 of the code a Hadamard gate (H) is applied to qubit b. The Hadamard gate transforms the |0 [symbol] state of qubit b to the |+ [symbol] state, which is a superposition of |0 [symbol] and |1 [symbol] with equal probability. Then, at line 10 of the above code a controlled NOT gate (CNOT) is applied with qubit b as the control qubit and qubit c as the target qubit. In a CNOT gate, if the control qubit is in the state |1 [symbol] , it applies a NOT gate to the target qubit. The resulting state is a Bell pair between qubits b an c. The state of qubits b and c is now a superposition of |00 [symbol] and |11 [symbol] with equal probability.

In lines 12 and 13 of the above code, the teleportation is performed in which the sender qubit is qubit a. In line 12, a CNOT gate with qubit a as the control qubit and qubit b as the target qubit is performed. Then, in line 13, a Hadamard gate is applied to qubit a. Thus, the overall state of qubits a, b and c is entangled. In line 14 the state of qubit a is measured and this measurement (which is either a “0” or a “1”) is placed in meas1 while in line 15 the state of qubit b is measured and this measurement (which is either a “0” or a “1”) is placed in meas2 thereby collapsing the combined state into the values (0,0), (1,0), (0,1), or (1,1).

The remainder of the above code makes a dynamic decision on what correction to apply to the qubits, if any. Such a decision cannot be made at the outset of running the program, which correction to apply is dependent on the state of the qubits after measurement. FIG. 7 illustrates code for a block that performs the same above described teleportation.

At line 16 the first block branches to either block @meas1_1_is_0 or @meas1_is_1 depending on the value of meas1. That is, if the value of meas1 is 0 process control passes to @meas1_is_0 whereas if the value of meas1 is 1, process control passes to @meas1_is_1.

If program control passes from block @start to block @meas1_is_0, no correction is necessary and process control therefore passes to either block @meas2_1_is_0 or @meas2_is_1 based on the value of meas2 in accordance with line 20 of the above code. That is, if the value of meas2 is 0 process control passes to @meas2_is_0 whereas if the value of meas2 is 1, process control passes to @meas2_is_1.

If program control passes from block @start to block @meas1_is_1, correction is necessary. Line 23 applies a z correction to qubit c. Then process control passes to either block @meas2_1_is_0 or @meas2_is_1 based on the value of meas2 in accordance with line 25 of the above code. That is, if the value of meas2 is 0 process control passes to @meas2_is_0 whereas if the value of meas2 is 1, process control passes to @meas2_is_1.

If program control passes to block @meas2_is_0, no correction is necessary and the program terminates normally in accordance with line 28 of the code.

If program control passes to block @meas2_is_1, correction is necessary. Line 32 applies an x correction to qubit c and the program terminates normally in accordance with line 32 of the code.

### Example System Implementation

In some embodiments, the CSAM is an abstract machine that can execute programs structured as described above. In some instances, the CSAM begins in the starting state, executes the list of operations contained in the corresponding starting block of the program and then applies the transition rule to move to the next state of the system. For each subsequent state entered, the CSAM executes the operation list in the corresponding block, and then transitions to a new state or halts as dictated by the transition rule in the corresponding block.

A physical system can be constructed that can simulate the CSAM, by implementing functional equivalents of the elements of the CSAM.

The classical memory and classical processor can be implemented using conventional computer technologies, such as using a conventional computer, an FPGA or ASIC, or a combination of several such elements.

The controlled quantum system can be implemented using any physical system which supports a universal set of quantum logic operations, such as a trapped ion, superconducting, or photonic quantum processor, together with the necessary control electronics required to implement sequences of quantum operations on the system.

The finite state machine control system can be implemented using conventional computing, such as on an FPGA, connected to both the classical processor and memory and the controlled quantum system.

Messaging to and from the user can be implemented over a network connection or communications bus, connected either directly to the finite state machine or classical processor.

### Example Compilation and Execution as a Sequence of Circuit Evaluations

A quantum program of the form described above generally cannot be executed using a single quantum circuit evaluation. It is, however, possible to obtain the results of executing, such a program making use of a system that is only capable of evaluating quantum circuits that avoids the need to adapt the circuit while it is being run, avoiding the need for any feed-forward logic. Some embodiments provide a compiler, described below, for this purpose.

In some embodiments, the compiler implements a virtual control system to simulate the process of executing the quantum program. The compiler attempts to mimic the behavior of the finite state machine control system, recording the values of the classical memory and the instructions to be sent to the controlled quantum system.

If the program does not require feed-forward adaption, meaning that no branch rules are encountered that depend on measurement results obtained from the controlled quantum system and no quantum operation is parameterized by the result of a measurement, this simulation runs until completion and the resulting transcript constitutes a single quantum circuit that can be evaluated using the hardware available.

If, however, the simulation requires access to the result of a quantum measurement to determine its next action, it terminates. The transcript up to this point constitutes a quantum circuit that includes the quantum measurements that blocked further simulation. This circuit can be executed one or more times on the available hardware to obtain a fair sampling of the measurement outcomes for the blocking measurements. Such sampling typically involves applying the quantum circuit to the requisite number of qubits, qudits, and/or quantum continuous variables specified by the quantum circuit, where the qubits, qudits, and/or quantum continuous variables are in the appropriate initial state prior to application of the quantum circuit, then measuring the state of the qubits, qudits, and/or quantum continuous variables (which collapses the state of each qubit, qudit and/or quantum continuous variable to a zero or a one), resetting the qubits, qudits, and/or quantum continuous variables to the appropriate initial state and then repeating the process of application of the quantum gate followed by qubit, qudit, and/or quantum continuous variable state measurement. This resetting to the appropriate initial quantum state, application of the quantum gate, and qubit, qudit, and/or quantum continuous variables state measurement is repeated a number of times in order to get statistics on the state of each qubit, qudit, or quantum continuous variable to which the gate was applied. In some embodiments, the process is repeated 10 or more times, 100 or more times, or between 5 and 5000 times. After the quantum measurement that was preventing the compiler from proceeding is performed in this fashion, in some embodiments, the compiler is then rerun, but when blocking measurements are encountered, the compiler uses the above described statistics of the last run to ‘guess’ the output of these measurements and continues as if they are known, until it completes or terminates at a new set of blocking quantum measurements.

In some embodiments, the process of running on hardware is repeated to obtain statistics for the new set of blocking quantum measurements, post-selecting only on those runs for which the ‘guesses’ for previous blocking measurements exactly match the measurement result obtained in the run.

This procedure is repeated as necessary until the simulation runs to completion, and a final hardware run is performed. In the absence of noise or hardware imperfections, the results from this final hardware run should follow the same distribution as a run of the original program on the CSAM.

Note that the above example procedure makes use of a simulation of the logic of the classical control systems only (the finite state machine, the classical memory and the classical processor), and no simulation of the controllable quantum system is required or performed. Such simulation can in general be performed efficiently.

Note that in general the number of runs required to evaluate an adaptive quantum program using non-adaptive circuits can grow rapidly for programs with many interdependent measurements.

Example Compilation from High-Level Languages

In some embodiments, flow control structures from higher level languages, such as for loops, while loops, if else conditionals and subroutine calls, are implemented using fixed constructions in the present disclosure, similarly to how such structures can be compiled to assembly or machine instructions in classical computing. This is essentially translating the blocks in a flow control diagram into the type of blocks processed by the CSAM.

An example IF-ELSE is shown below.

```
if <bool_condition> {
  <code1>
} else {
  <code2>
}
```

This example can be implemented using blocks shown below:

```
@if_open | @true_branch, @false_branch
  <boo1_condition> -> flag
branch(flag)
@true_branch | @if_close
  <code1>
advance
@false_branch | @if_close
  <code2>
advance
@if_close | @next_segment
advance
```

In the example shown above, items appearing as <item> are place holders for whatever code or boolean condition a programmer may use. @next_segment is the label of the next segment of code to advance to after the if. Similar convention is used for the other constructions described below.

An example WHILE is shown below.

while <boo1_condition> {
<code>
}

This WHILE can be implemented using blocks as shown below.

```
@while_open | @next_segment, @while_body
  <boo1_condition> -> flag
branch(flag)
@while_body | @while_open
  <code>
advance
```

An example DO-WHILE is shown below.

do {
<code>
} while <bool_condition>

This DO-WHILE can be implemented using blocks shown below:

```
@do | @next_segment, @do
  <code>
  <bool_condition> -> flag
branch(flag)
```

An example FOR is shown below:

for (<initialization>, <condition>, <update>) {
<body_code>

This FOR can be implemented using blocks as shown below.

```
@for_open | @for_gate
  <initialization>
advance
@for_gate | @next_segment, @for_body
  <condition> -> flag
branch(flag)
@for_body | @for_gate
  <body_code>
  <update>
advance
```

Some embodiments implement GOSUB-RETURN as follows. Equivalents of various subroutine and function calls can also be constructed. In some embodiments, the compiler (compiling from a higher level language to a CSAM program) initially constructs a list of locations from which the subroutine or function is called, which are used as successor blocks for the function block. Classical variables are used to implement a call stack.

The 7th unique location in the code from which a subroutine is called (e.g., gosub mysub) becomes

```
@call_block | @sub_mysub
  call_depth + 1 -> call_depth # increment call depth
  7 -> return_address.[call_depth]
advance
@return_block | @next_segment
  call_depth - 1 -> call_depth # decrement call depth
advance
```

In this instance @return_block would be the 7th successor block for @sub_mysub.

@sub_mysub | ... , @return_block, ...
<subroutine_code>
branch(return_address.[call_depth])

### Example Block Names

In the above discussion, fixed names were used for each block, however for a CSAM program to be valid, each block has a unique name, and so the compiler generates a unique identifier for each block rather than relying on the fixed naming in the above templates.

### Example Nesting Support

The above only discussed constructions for individual flow control constructions in isolation. In practice, from control constructions are often nested and the above constructions can be easily nested by working from the outermost flow control inwards (as discussed below), or from the inner most statements outward.

Working from outermost flow control in, flow control statements will appear within the body code of blocks in intermediate steps during the compilation. If viewed inside out, there are block structures appearing within flow control statements in intermediate steps. The description below uses outside-in direction.

These can be iteratively broken down into blocks as follows.
The parent block is split into two blocks: a parent_opening block and a parent_closing block.
The sequence of operations and flow control in the block body are broken down into a series of blocks, where the outermost flow control in these blocks is replaced using the block constructions in the templates above, which are chained together using the advance rule.
The parent_opening block retains the label of the original parent block, with an advance rule where the successor block is set as the first block in the newly created chain created.
The successor block of the final block in the newly created chain is set to the parent_closing block.

With each iteration of this procedure, the nesting level of flow control within blocks is reduced by one, so the process can be repeated a finite number of times (equal to the level of nesting of flow control in the original program) to eliminate all flow control from blocks, resulting in a valid CSAM program.

### Nesting Example

A nesting example is shown below.

```
while <cond1> {
  <code 1
  while <cond2> {
    <code2>
  }
  <code3>
  if <cond3> {
    <code4>
  } else {
    <code5>
  }
}
```

This nesting example is converted to the following intermediate form after one pass.

```
@while_open_1 | @next_segment, @while_body_1
  <cond1> -> flag1
branch(flag1)
@while_body_1 | @while_open_1
  <code1>
  while <cond2> {
    <code2>
  }
  <code3>
  if <cond3> {
    <code4>
  } else {
    <code5>
  }
advance
```

This is later converted to a valid CSAM program after a second pass.

```
@while_open_1 |@next_segment, @while_body_1
  <cond1> -> flag1
branch(flag1)
@while_body_1 | @child_1
advance
@child_1 | @while_open_2
  <code1>
advance
@while_open__2 |@child_2, @while_body_2
  <cond2> -> flag2
branch(flag2)
@while_body_2 | @while_open_2
  <code2>
advance
@child_2 |@if_open_1
  <code3>
advance
@if_open_1 | @true_branch_1, @false_branch_1
  <cond3> -> flag3
branch(flag3)
@true_branch_1 | @if_close_1
  <code4>
advance
@false_branch_1 | @if_close_1
  <code5>
advance
@if_close_1 | @while_body_1_close
advance
@while_body_1_close | @while_open_1
advance
```

### Example Optimization

In some embodiments, trivial flow control, such as chains of empty blocks with advance rules, are eliminated by an optimization pass, which merges blocks where it is possible to do so. This occurs, for example, when the first block in a chain has an advance rule and is the only possible predecessor within the program to its specified successor block, in which case a single block can be formed by concatenating the operation list of the first and second block into a block with the same label as the first block and the same successor list and rule as the second block.

One specific example is shown below for illustration.

```
@block1 | block2
  <code1>
advance
@block2 | @block3, @block4
  <code2>
  <cond> -> path
branch(path)
```

This example is optimized shown below:

```
@block1 | @block3, @block4
  <codel>
  <code2>
  <cond> -> path
branch(path)
  if @block2 is a successor block only to @block1.
```

if @block2 is a successor block only to @block1.

### Simulating a Turing Machine Using a CSAM Program

Prior researchers have provided explicit constructions for simulating a quantum Turing machine up to step t with quantum circuits, which can be adapted to construct a CSAM that can directly simulate a Turing machine for indefinite t.

### Example System and Method for Performing a Quantum Computation

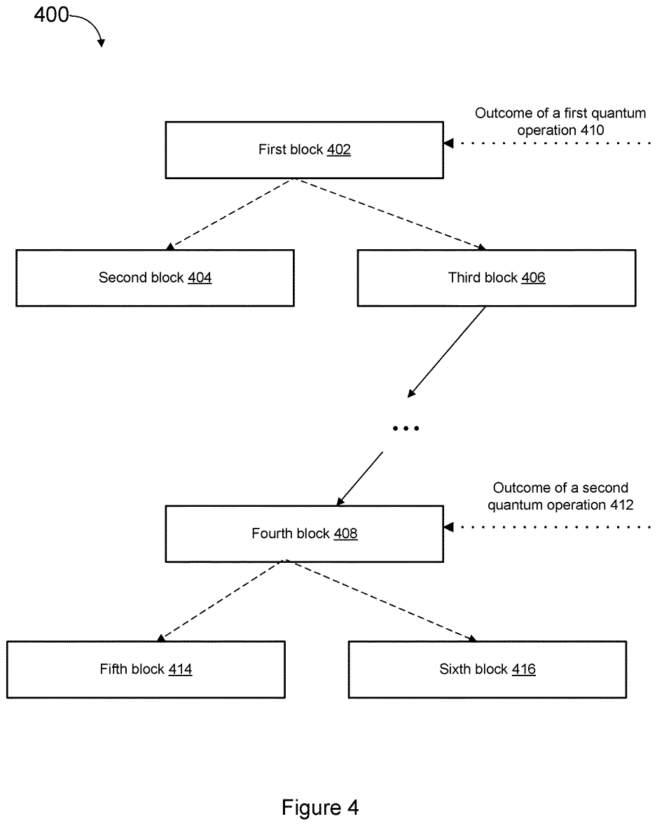

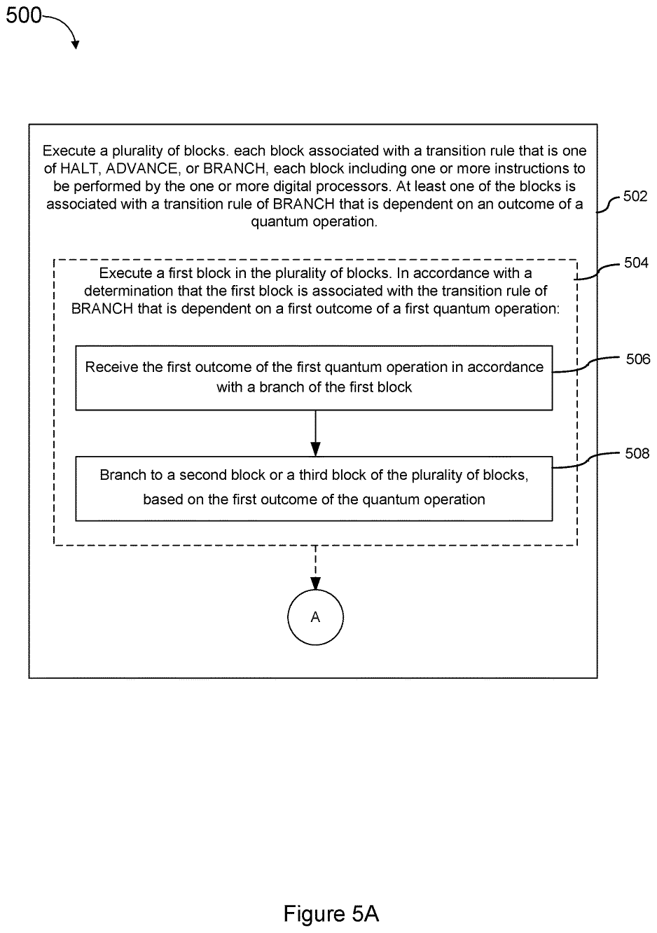

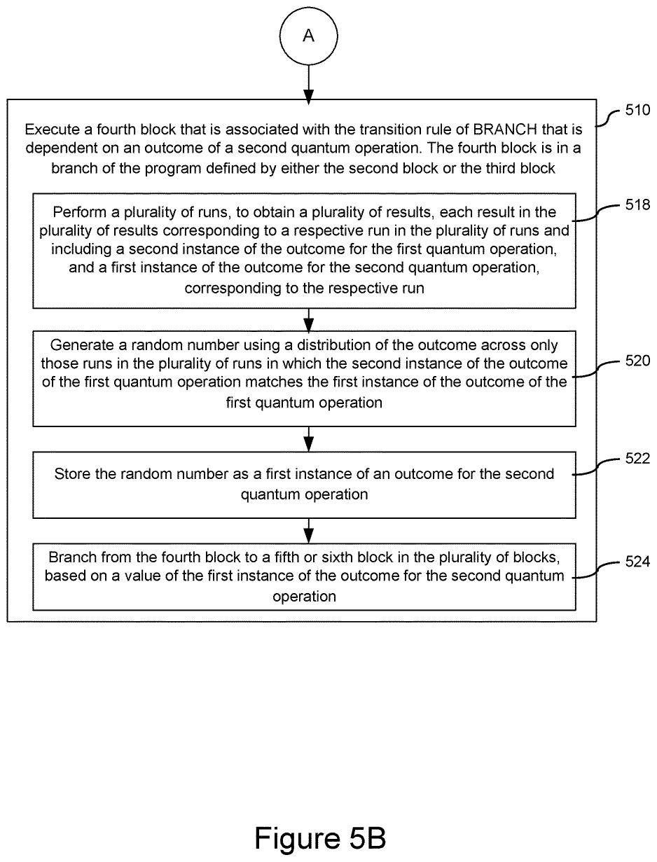

FIG. 4 is a schematic diagram of an example block layout 400, and FIGS. 5A and 5B show a flow chart for an example method 500 for performing quantum computations, in accordance with one or more embodiments of the present disclosure. As described above in reference to FIGS. 1 and 2, a computer system 100 includes one or more digital processors (e.g., the CPU 74), a memory 92 and a module compiler 20 (module 20). The memory 92 includes a program expressed as a plurality of blocks. Examples of blocks are described above. Each block is associated with a transition rule 18 that is one of HALT, ADVANCE, or BRANCH. Each block includes one or more instructions 16 to be performed by the one or more digital processors and/or by the quantum processor. At least one of the blocks is associated with a transition rule 18 of the type BRANCH that is dependent on an outcome of a quantum operation. Note that it is also possible for transitions rules 18 of the type BRANCH to be dependent on an outcome of a classical (digital) computation, however, in the present instance there is a requirement that at least one BRANCH is dependent on an outcome of a quantum operation. For example, in FIG. 4, a first block 402 and a fourth block 408 are dependent on outcome 410 and outcome 412, respectively. Operations of the module 12 are further described below in reference to FIGS. 4, 5A and 5B, in accordance with one or more embodiments.

Referring to FIG. 5A, the module 20 is configured to execute (502) the plurality of blocks, such as the blocks 402, 404, 406, and 408, and any other preceding, intervening, and succeeding blocks. It will be noted that blocks 402, 404, 406, and 408 of FIG. 4 are of the same type at blocks as those described above in conjunction with FIG. 2 (blocks 12). The module 20 is configured to execute (504) the instructions 16 of the first block 402 in the plurality of blocks. Once these instructions have been executed and the first block has reached its final state the transition rule 18 of the first block is executed. In accordance with a determination that the first block 402 is associated with the transition rule of BRANCH that is dependent on a first outcome 410 of a first quantum operation, the module 20 receives (506) the first outcome 410 of the first quantum operation (e.g., from the quantum system 308) in order to determine how to handle a branch defined by the first block. The module 20 branches (508) to a second block 404 or a third block 406 of the plurality of blocks, based on the first outcome 410 of the quantum operation. For example, in some embodiments the quantum operation is performed on a single qubit, qudit, or quantum continuous variable and a measurement of the single qubit, qudit, or quantum continuous variable is collapsed into either a zero or one depending on the measured value of the qubit, qudit, or quantum continuous variable. If the collapsed value is zero, the second block 404 is executed. If the collapsed value is one, the third block 406 is executed. In some embodiments, the first quantum operation is performed a plurality of times in order to arrive at a distribution of values for the quantum measurement. For instance, in some embodiments, in evaluating the transition rule of block 402, the first quantum measurement is run on a quantum system 100 or more times, 1000 or more times or 10,000 or more times, each time arriving at a measurement of the same first quantum operation. In some embodiments, the first quantum operation is encoded as one or more gates that operate on one or more qubits, qudits, and/or quantum continuous variables of the quantum system. In some embodiments, the first quantum operation comprises one, two, three, four, five, six, seven, eight, nine, or ten or more quantum gates. In some embodiments, some of the gates operate on the same or different qubits, qudits, and/or quantum continuous variables in the quantum system. In some embodiments, 1, 2, 3, 4, 5, 6, 7, 8, 9, 10, or more than 11 qubits, qudits, and/or quantum continuous variables of the quantum system are used to evaluate the first quantum operation. Returning to the example, in instances where the first quantum operation is performed multiple times, the result from the quantum operation can be evaluated in different ways. In one such way, one of the quantum operation results is selected from among all the quantum operation results (that is, from among one of the many instances of running the first quantum operation). For example, consider the case where the first quantum operation is run 1000 times. One can randomly select one of the results and use that as the basis for evaluating the transition rule of the first block 402. Alternatively, the distribution of results from all the times the first quantum operation was run for block 506 of FIG. 5A can be used to set up a random number generator that generates a random result for the first quantum operation in accordance with the outcome distribution statistics for the first quantum operation. So, consider the case where the first quantum operation is measured on a single qubit, qudit, or quantum continuous variable whose value is collapsed to a classical zero or one upon quantum measurement. Suppose that this first quantum measurement is performed a nominal 1000 times and that 62 percent of the time the qubit, qudit, or quantum continuous variable was measured to have value zero and 38 percent of the time the qubit is measured to have value one. In this instance, to evaluate the transition rule of block 402, a random number generator is set up to randomly select a value of zero or one. However, the random number generator, in so doing, has a probability of 62 percent of generating a zero and has a probability of 38 percent of generating a one. Whatever, value the random number generates is then considered to be the first outcome of the first quantum operation in accordance with this example of block 506. That is, it is considered to be the first instance of the outcome of the first quantum measurement.

In some embodiments, the plurality of blocks includes a fourth block 408 that is associated with the transition rule of BRANCH that is dependent on an outcome 412 of a second quantum operation. For purposes of illustration, and in accordance with FIG. 4, this fourth block occurs downstream of a branch initiated by the third block 406. However, it will be appreciated that the fourth block could have been in a branch initiated by the second block 404. Referring to FIG. 5B, the module 12 executes (510) the fourth block as follows. The fourth block 408 is in a branch of the program defined by the third block 406 in this example. Once process control of module 20 passes to the third block 406 it first executes all the instructions 16 of the third block 406 thereby brining the third block 406 to its final state, at which time it is now time to evaluate the transition rule 18 of the third block 406. This is done by performing (518) a plurality of runs. Each respective run in the plurality of runs causes the quantum system to perform the first quantum operation (410), on the quantum system, to obtain an instance of the first outcome, and causes the quantum system, after performing the first quantum operation of the respective run, to perform the second quantum operation (412), irrespective of a value of the instance of the first outcome, to obtain an instance of a second outcome of the second quantum operation. In this way, or any alternate similar or efficient manner (e.g., repeat the first quantum operation several times but perform the second quantum operation only once), the module 12 obtains a plurality of results, each result in the plurality of results corresponding to a respective run in the plurality of runs and including an instance of the first outcome and an instance of the second outcome corresponding to the respective run. Then, a second random number is generated using a distribution of the second outcomes across only those runs in the plurality of runs in which the second instances of the first outcome of the first quantum operation matches the stored first instance of the first outcome of the first quantum operation. This second random number is stored (522) as a first instance of the second outcome for the second quantum operation. Moreover, a value of the first instance of the second outcome for the second quantum operation is used to branch (524) from the fourth block 408 to a fifth block 414 or a sixth block 416 in the plurality of blocks, based on the value of the second random number.

To illustrate, consider the case where the stored value for the first quantum operation 410 is a zero. In other words, the first random number was a zero. Then, for the transition rule for block 408, the goal is to obtain a second random number that will be stored value for the second quantum operation 412. The second quantum operation cannot be run directly. The first quantum operation is run first to bring the quantum system into the correct state for performing the second quantum operation. Each pair of first and second quantum operations is considered a run. Each run returns a measurement for the first quantum (associated with the transition rule of block 402) operation and a measurement of for the second quantum operation (associated with the transition rule of block 408). Consider the case where there were 1000 such runs and that, furthermore 45 percent of the runs have a value of one for the first quantum measurement while 55 percent of the runs have a value of zero for the first quantum measurement. In the case where the stored value for the first quantum measurement from step 506 of FIG. 5A is a zero, 450 of the runs are discarded and not used to develop statistics for the second quantum measurement because, for these 450 runs, the quantum system was in the incorrect state when arriving to perform the second quantum measurement. Thus, the 550 runs that had a value of one for the first quantum measurement (and thus matching the stored value for first instance of the first quantum measurement from block 506) are evaluated. Again consider a simple case where the second measurement is once again the measurement of the value of a single qubit, qudit, or quantum continuous variables, i.e., a zero or one. Further consider, that among the 550 runs that will be used to evaluate the second measurement, 300 of them had a value of one while the remainder have a value of 150. Thus, when a random number generator is used to come up with a value for the outcome of the second quantum operation, the random number generator returns a zero or one, now with a probability of 300/550 of being a one and probability 150/550 of being a zero. This second random number, whatever it is (zero or one), is then stored as the first instance of the outcome of the second quantum measurement. Moreover, its value is used as the basis for branching to either block the fifth block 414 (e.g., if the first instance of the outcome of the second quantum measurement is zero) or the sixth block 416 (e.g., if the first instance of the outcome of the second quantum measurement is one). All future runs along the branch defined by the first block 402 and the third block 406, for instance when a third quantum measurement is needed to evaluate a third branch, in order to be considered for evaluation of such subsequent branches must perform the first quantum operation with a first measurement matching the first stored random number (for the first instance of the outcome of the first quantum operation 410) and a second measurement matching the second stored random number (for the first instance of the outcome of the second quantum operation 412). In some embodiments, rather than using a random number generator to identify the first instance of the outcome of the first quantum measurement in block 506, one of the measurements performed for the first quantum operation is randomly selected to be the first instance of the outcome of the first quantum measurement.

While the above example has been described using a single qubit, qudit, or quantum continuous variable measurement for the outcome of the first instance of the first quantum measurement and the outcome of the first instance of the second quantum measurement, it will be appreciated that the present disclosure is not so limited. In practice, the first, second, and subsequent quantum operations can be across more than one qubit, qudit or quantum continuous variable. For instance, consider the case where the quantum operation is across five qubits, qudits, or quantum continuous variables and, upon measurement, thereby returns a five element array, where each element is a zero or a one. The operation is run several times, and the probability of each possible value for the five element array is used by a random number generator to generate a random value for the five element array. Thus, for instance, consider the case where the first instance of the first quantum operation at block 506 performs the first quantum operation 1000 times, returning the array [1,0,0,0,1] ten percent of the time, the array [1,1,1,1,1] 65 percent of the time, and the array [1,0,1,1,1] 25 percent of the time, and never returning any other possible values for the array. In this instance, to arrive at the outcome of the first instance of the quantum operation, the random number generator is set to generate the value [1,0,0,0,1], [1,1,1,1,1] or [1,0,1,1,1]. The random number does so, with a probability of ten percent of returning [1,0,0,0,1], a probability of 65 percent of returning [1,1,1,1,1], and a probability of 25 of returning [1,0,1,1,1].

In some embodiments, the module 12 is coupled to the memory, the one or more digital processors and the quantum system. For example, in FIG. 3, the control system 306 is coupled to the controlled quantum system 308, classical processor 310, and the classical memory 302. The module 12 is configured according to a finite state machine, to be in a state of a plurality of states of the finite state machine. Each block of the plurality of blocks corresponds to a state. For example, in reference to FIG. 4, the block 402 and the block 408 are associated with a BRANCH state. The blocks 408 and 406 are associated with an ADVANCE state. Although not shown, the program may include one or more blocks which may be associated with a HALT state, so that the programs in the layout 400 will halt after execution. The module 12 is configured to: upon entering a state of the plurality of states, perform a sequence of operations, using the memory, the one or more digital processors, and the quantum system; and after the sequence of operations, transition to another state, based on the transition rule of HALT, ADVANCE, or HALT. In some embodiments, the sequence of operations includes obtaining input from a user 304 to the memory or transmitting variables stored in the memory to the user. In some embodiments, the user 304 is an operator of the system, another system or network, or a combination thereof.

In some embodiments, each state of the plurality of states includes a predetermined set of successor states to transition to.

In some embodiments, the module 12 is further configured to, upon determination that the predetermined set of successor states is empty for a state that has no successor states, halt execution, thereby allowing the memory to be read out.

In some embodiments, the module 12 is further configured to, upon determination that a current state has no successor states, applying the HALT transition rule to cease performing computations after performing operations corresponding to the current state.

In some embodiments, the module 12 is further configured to: upon determination that a current state has a single successor state, applying the ADVANCE transition rule to transition to the single successor state after performing operations corresponding to the current state.

In some embodiments, the module 12 is further configured to: upon determination that a current state has multiple successor states, applying the BRANCH transition rule to transition to one of the successor states after performing operations corresponding to the current state.

In some embodiments, the first outcome is a measurement outcome for one or more qubits, qudits, or quantum continuous variables defined by the first block.

In some embodiments, the first block includes a series of quantum gate level operations.

In some embodiments, the first block defines a quantum data structure.

In some embodiments, the quantum system 308 includes subsystems comprising qubit, qudits, and/or quantum continuous variables configured to perform quantum gates and quantum measurements.

In some embodiments, the memory 92 is configured to store numerical data, and the module 12 is further configured to index and/or address individual quantum systems of the subsystems.

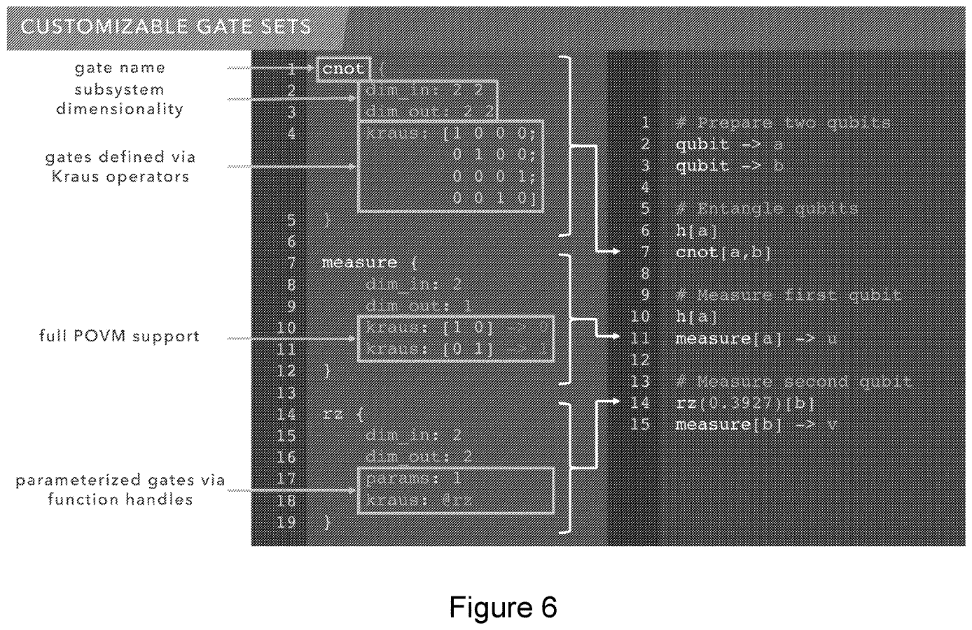

FIG. 6 illustrates how instructions 16 within blocks of the present disclosure can be coded so that they can be deployed on a quantum system. For example, with reference to FIG. 6, in the case of defining the CNOT (a, b) gate used at line 7 on the right side of FIG. 6, the CNOT gate is specified in line 1-4 of the middle panel of FIG. 6 in a data structure that provides the name of the gate “CNOT”, the number of dimensions on the subset systems, and the appropriate Kraus operators. Here, “dim_in: 2 2” means that the first subsystem is of dimension two (i.e. a qubit, qubit, or quantum continuous variable), and the second subsystem is of dimension two. To define how the CNOT gate interacts with a qubit, the appropriate Kraus operators for the CNOT operation are specified: [1000; 0100; 000 1; 0 0 1 0].

As another example, line 10 of the instructions 16 on the right portion of FIG. 6, calls for h[a]. In some embodiments, h[a] is defined in a separate data structure as:

```
  h {
    dim_in: 2
    dim_out: 2
    kraus: [0.7071067811865475 0.7071067811865475; 0.7071067811865475 -
0.7071067811865475]
  }
```

That is, the name of the data structure is “h,” the dimensions are specified (“dim_in:2”; “dim_out 2”), and the Kraus operators are defined for h[a].

Turning to the “measure” example at line 11 of the instructions 16 on the right side of FIG. 5, general positive operator-valued measures (POVMs) are supported. Therefore, any set of Kraus operators corresponding to digital outputs can be specified. In the measure example at line 11 of the right portion of FIG. 6, the name of the gate (“measure”), the number of dimensions (“dim_in: 2”; “dim_out: 1”) and the Kraus operators for the measure gate (“Kraus: [1 0]->0”; “Kraus [0 1]->1”) are specified in a separate data structure illustrated as lines 7-12 in the middle panel of FIG. 6.

Moreover, referring to line 14 of the instructions 16 on the right hand side of FIG. 6, parameterized gates are supported where the Kraus operators are given by function handles. This produces the Kraus operator when passed a value for the parameter and allows for implementation of arbitrary parameterized gates. Thus, the code rz (0.3927)[b] passes the parameter value 0.3927 to the rz gate that is defined in the middle panel of FIG. 6. In some embodiments, these function handles are called to generate the Kraus operators (e.g., on the fly) for whatever parameters have been specified by the gate. More details on how instructions 16 are supported as hydrogen language statements is found in International Publication No. WO 2021/118464 A1 entitled “Systems and Methods of Unified Computing on Digital and Quantum Computers” and U.S. patent application Ser. No. 17/337,873, filed Jun. 3, 2021, entitled “Systems and Methods of Unified Computing on Digital and Quantum Computers” each of which is hereby incorporated by reference.

In some embodiments, each respective quantum gate in the instructions 16 is defined in a different data structure that includes a name of the respective gate, a first dimension of a respective input of a respective subsystem-gate (in terms of a number of qubits, qudits, and/or quantum continuous variables) and/or a second dimension of a respective output of the respective subsystem-gate (in terms qubits, qudits, and/or quantum continuous variables), and a corresponding plurality of Kraus operators for the respective quantum gate. In some such embodiments, the corresponding plurality of Kraus operators for the respective gate is specified by a function handle. In other embodiments, a subset of the corresponding plurality of Kraus operators for the respective gate is specified by a function handle.

### CONCLUSION AND REFERENCES CITED

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a non-transitory computer readable storage medium. For instance, the computer program product could contain the program modules shown or described above in any combination of FIGS. 1 through 5B. These program modules can be stored on a CD-ROM, DVD, magnetic disk storage product, USB key, or any other non-transitory computer readable data or program storage product.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

1. A system for performing a quantum computation, the system comprising:
one or more digital processors;
a memory comprising a program expressed as a plurality of blocks, each block associated with a transition rule that is one of HALT, ADVANCE, or BRANCH, each block including one or more instructions to be performed by the one or more digital processors, wherein at least one of the blocks is associated with a transition rule of BRANCH that is dependent on an outcome of a quantum operation; and
a module configured to (i) execute the plurality of blocks, and (ii) receive, from a quantum system, a corresponding outcome for each quantum operation, the module configured to:
execute a first block in the plurality of blocks, wherein in accordance with a determination that the first block is associated with the transition rule of BRANCH that is dependent on a first outcome of a first quantum operation:
receive the first outcome of the first quantum operation in accordance with a branch of the first block; and
branch to a second block or a third block of the plurality of blocks, based on the first outcome of the quantum operation.

2. The system of claim 1, wherein the plurality of blocks includes a fourth block that is associated with the transition rule of BRANCH that is dependent on an outcome of a second quantum operation, wherein the fourth block is in a branch of the program defined by either the second block or the third block, and wherein the module is further configured to:
cause the quantum system to perform the first quantum operation, a first plurality of times, to obtain a plurality of first instances of an outcome of the first quantum operation;
select a first instance of an outcome from the plurality of first instances of the outcome of the first quantum operation;
store the selected first instance of the outcome of the first quantum operation in the memory;
perform a plurality of runs, wherein each respective run in the plurality of runs:
causes the quantum system to perform the first quantum operation, on the quantum system, to obtain a corresponding second instance of the outcome of the first quantum operation, and
causes the quantum system, after performing the first quantum operation of the respective run, to perform the second quantum operation, irrespective of a value of the second instance of the outcome of the first quantum operation, to obtain a corresponding first instance of an outcome of the second quantum operation,
thereby obtaining a plurality of results, each result in the plurality of results corresponding to a respective run in the plurality of runs and including a second instance of the outcome of the first quantum operation and a first instance of the outcome of the second quantum operation corresponding to the respective run;
generate a random number using a distribution of the first instance of the outcome of the second quantum operation across only those runs in the plurality of runs in which the corresponding second instance of the outcome of the first quantum operation of the respective runs matches the selected first instance of the outcome of the first quantum operation;
store the random number as a selected first instance of the outcome for the second quantum operation; and
branch from the fourth block to a fifth or sixth block in the plurality of blocks, based on the selected first instance of the outcome for the second quantum operation.

3. The system of claim 1, wherein:
the module is coupled to the memory, the one or more digital processors and the quantum system;
the module is configured according to a finite state machine, to be in a state of a plurality of states of the finite state machine, wherein each block of the plurality of blocks corresponds to a state; and
the module is configured to:
upon entering a state of the plurality of states, perform a sequence of operations, using the memory, the one or more digital processors, and the quantum system; and
after the sequence of operations, transition to another state, based on the transition rule of HALT, ADVANCE, or BRANCH.

4. The system of claim 3, wherein the sequence of operations includes obtaining input from a user to the memory or transmitting variables stored in the memory to the user.

5. The system of claim 4, wherein the user is an operator of the system, another system or network, or a combination thereof.

6. The system of claim 3, wherein each state of the plurality of states includes a predetermined set of successor states to transition to.

7. The system of claim 6, wherein the module is further configured to:
upon determination that the predetermined set of successor states is empty for a state that has no successor states, halt execution, thereby allowing the memory to be read out.

8. The system of claim 3, wherein the module is further configured to:
upon determination that a current state has no successor states, applying the HALT transition rule to cease performing computations after performing operations corresponding to the current state.

9. The system of claim 3, wherein the module is further configured to:
upon determination that a current state has a single successor state, applying the ADVANCE transition rule to transition to the single successor state after performing operations corresponding to the current state.

10. The system of claim 3, wherein the module is further configured to:
upon determination that a current state has multiple successor states, applying the BRANCH transition rule to transition to one of the successor states after performing operations corresponding to the current state.

11. The system of claim 1, wherein the outcome of the first quantum operation is a measurement outcome for one or more qubits, qudits, or quantum continuous variables defined by the first block.

12. The system of claim 1, wherein the first block includes a series of quantum gate level operations.

13. The system of claim 1, wherein the first block defines a quantum data structure.

14. The system of claim 1, wherein the quantum system includes subsystems comprising qubits, qudits, or quantum continuous variables configured to perform quantum gates and quantum measurements.

15. The system of claim 14, wherein the memory is configured to store numerical data, where in the module is further configured to index and/or address individual quantum systems of the subsystems.

16. A method for performing a quantum computation using a system comprising (a) one or more digital processors, (b) a memory comprising a program expressed as a plurality of blocks, each block associated with a transition rule that is one of HALT, ADVANCE, or BRANCH, each block including one or more instructions to be performed by the one or more digital processors, wherein a first block in the plurality of blocks is associated with a transition rule of BRANCH that is dependent on an outcome of a first quantum operation, and (c) a module, the method comprising:
at the module:
(i) executing the plurality of blocks, and (ii) receiving, from a quantum system, an outcome for the first quantum operation, including:
executing the first block, wherein in accordance with a determination that the first block is associated with the transition rule of BRANCH that is dependent on the outcome of the first quantum operation:
receiving the outcome of the first quantum operation in accordance with the transition rule of BRANCH of the first block; and
branching to a second block or a third block of the plurality of blocks, based on a value of the outcome of the first quantum operation.

17. The method of claim 16, wherein the plurality of blocks includes a fourth block that is associated with the transition rule of BRANCH that is dependent on an outcome of a second quantum operation, wherein the fourth block is in a branch of the program defined by either the second block or the third block, the method further comprising:
at the module:
causing the quantum system to perform the first quantum operation, a first plurality of times, to obtain a plurality of first instances of an outcome of the first quantum operation;
selecting a first instance of an outcome from the plurality of first instances of the outcome of the first quantum operation;
storing the selected first instance of the outcome of the first quantum operation in the memory;
performing a plurality of runs, wherein each respective run in the plurality of runs:
causes the quantum system to perform the first quantum operation, on the quantum system, to obtain a corresponding second instance of the outcome of the first quantum operation, and
causes the quantum system, after performing the first quantum operation of the respective run, to perform the second quantum operation, irrespective of a value of the second instance of the outcome of the first quantum operation, to obtain a corresponding first instance of an outcome of the second quantum operation,
thereby obtaining a plurality of results, each result in the plurality of results corresponding to a respective run in the plurality of runs and including a second instance of the outcome of the first quantum operation and a first instance of the outcome of the second quantum operation corresponding to the respective run;
generating a random number using a distribution of the first instance of the outcome of the second quantum operation across only those runs in the plurality of runs in which the corresponding second instance of the outcome of the first quantum operation of the respective runs matches the selected first instance of the outcome of the first quantum operation;
storing the random number as a selected first instance of the outcome for the second quantum operation; and
branching from the fourth block to a fifth or sixth block in the plurality of blocks, based on the selected first instance of the outcome for the second quantum operation.

18. The method of claim 16, wherein:
the module is coupled to the memory, the one or more digital processors and the quantum system;
the module is configured according to a finite state machine, to be in a state of a plurality of states of the finite state machine, wherein each block of the plurality of blocks corresponds to a state; and
the method further comprising:
at the module:
upon entering a state of the plurality of states, perform a sequence of operations, using the memory, the one or more digital processors, and the quantum system; and
after the sequence of operations, transition to another state, based on the transition rule of HALT, ADVANCE, or BRANCH.

19. The method of claim 18, wherein the sequence of operations includes obtaining input from a user to the memory or transmitting variables stored in the memory to the user.

20. A non-transitory computer readable storage medium storing a module and a program expressed as a plurality of blocks, each block associated with a transition rule that is one of HALT, ADVANCE, or BRANCH, wherein a first block in the plurality of blocks is associated with a transition rule of BRANCH that is dependent on an outcome of a first quantum operation, each block including one or more instructions, and wherein the module, when executed by a digital computer system with one or more digital processors, causes the digital computer system to:
(i) execute the plurality of blocks, and (ii) receive, from a quantum system, an outcome for the first quantum operation, including:
execute the first block, wherein in accordance with a determination that the first block is associated with the transition rule of BRANCH that is dependent on the outcome of the first quantum operation:
receive the outcome of the first quantum operation in accordance with a branch of the first block; and
branch to a second block or a third block of the plurality of blocks, based on the outcome of the first quantum operation.
